(19) United States
(12) Patent Application Publication
(10) Pub. No.: US 2019/0271717 A1
(43) Pub. Date: Sep. 5, 2019

(54) ACCELEROMETER SENSOR

(71) Applicant: SIMON FRASER UNIVERSITY, Burnaby (CA)

(72) Inventors: Behraad BAHREYNI, Port Moody (CA); Albert LEUNG, Burnaby (CA); Fatemeh EDALATFAR, Coquitlam (CA); Abdulqader QURESHI, Burnaby (CA); Bahareh YAGHOOTKAR, Burnaby (CA); Kourosh KHOSRAVIANI, Clifton Park, NY (US)

(21) Appl. No.: 16/462,165

(22) PCT Filed: Nov. 20, 2017
(86) PCT No.: PCT/CA2017/051379

§ 371 Date: May 24, 2018

Related U.S. Application Data
(60) Provisional application No. 62/425,020, filed on Nov. 21, 2016.

(51) Int. Cl. G01P 15/125; G01P 15/08

(52) U.S. Cl. CPC G01P 15/125; G01P 15/0802

(57) ABSTRACT

A capacitive accelerometer sensor including first and second substrates is disclosed, wherein the first substrate comprises a resilient membrane having at least one first electrode and a proof mass attached to the resilient membrane; the second substrate includes at least one second electrode; and the first and second substrates are bonded to each other such that the first electrode of the resilient membrane on the first substrate faces the second electrode and is separated from the second electrode on the second substrate by a capacitive gap; and the first and second substrates comprise a plurality of openings and electrical contacts electrically connected to each of the first and second electrodes, respectively.

### RELATED APPLICATIONS

This patent application claims the benefit of U.S. Provisional Patent Application No. 62/425,020 filed Nov. 21, 2016 and entitled “ACCELEROMETER SENSOR.”

### TECHNICAL FIELD

An embodiment of the present invention relates generally to a Micro-Electro-Mechanical System (MEMS) device which measures acceleration forces. More particularly, a further embodiment relates to a MEMS out-of-plane configuration accelerometer sensor.

### BACKGROUND

An accelerometer is a transducer that is used to measure the physical or measurable acceleration that is experienced by an object. Depending on the design, the accelerometer responds to accelerations along one, two, or three axes. While there are examples of MEMS accelerometers without a proof mass such as is disclosed in U.S. Pat. No. 6,589,433 B2, in a typical MEMS accelerometer, as are known in the art, an external acceleration results in a force applied to a proof mass structure, hence displacing it with respect to a frame. The proof mass displacement can be detected through a variety of transduction mechanisms such as capacitive, piezoresistive, piezoelectric, tunneling, optical, heat transfer, Hall Effect, and thermal mechanisms, for example. Among different kinds of MEMS accelerometers, those with capacitive interfaces have typically attracted more attention in manufacturing high performance accelerometers due to their typical advantages in one or more performance characteristics such as higher sensitivity, repeatability of the output, temperature stability, design flexibility, lower cost, and lower power consumption.

In conventional MEMS accelerometer designs, the direction of the proof mass movement with respect to the frame may typically be either lateral (i.e., in-plane accelerometers) or vertical (i.e., out-of-plane accelerometers). Conventional capacitive in-plane accelerometers typically use sets of interdigitated comb fingers, with one set attached to the proof-mass and another to the frame, to achieve relatively large capacitances per unit area in order to improve the device sensitivity. Conventional out-of-plane capacitive accelerometers normally employ the top or bottom surfaces of the proof-mass as electrodes and measure their relative displacements to electrodes that are fixed to the frame and held across a predefined gap below or above the proof-mass.

For a typical MEMS accelerometer design as known in the art, there are typically several trade-offs to be made between sensitivity, noise, bandwidth, and linearity. To achieve high manufacturing yields and low-cost, several compromises are typically made at different stages of the MEMS design, or the design of its electronic interface. Typical MEMS accelerometers known in the art may have operating bandwidths that range from 10's to 100's of hertz with noise spectral densities in the range of 10's of μg/√Hz to several mg/√Hz (where g is a unit of acceleration, g≈9.81 m/s²). In some cases, a closed-loop feedback control may be used in a conventionally known design to improve the linearity of the sensor system which might otherwise be limited due to small operating gaps between the electrodes that are typically needed for high sensitivity.

In US Patent Application Number US 2005/0194652 A1, an accelerometer is described comprising three distinct layers of a semiconductor material, where an upper and a lower layer serve as fixed electrodes and a central layer serves as a seismic mass or proof mass as the moving electrode. The central layer which comprises the seismic mass is connected to the frame by springs. In such case, the described accelerometer encompasses the seismic mass suspended between the upper and lower electrodes by the springs connecting it to the frame surrounding it. Each fixed electrode thus forms with the seismic mass a capacitor whose capacitance depends on the surface area and characteristics of the seismic mass, the surface area and characteristics of the corresponding first and second electrodes, the distance separating these elements and on the dielectric constant of the matter, generally air, existing between them. However, the disclosed accelerometer requires separate first and second fixed electrodes, in addition to spring mechanisms to suspend the seismic mass from the frame and regulate travel of the seismic mass between the two electrode components.

In U.S. Pat. No. 8,372,677 B2, a tri-axis accelerometer is described, which comprises a substrate, proof mass, and electrodes. In order to form the proof mass a portion of the substrate is separated from an exterior support structure by a plurality of thin etched cavities. An electrically-conductive anchor is coupled to the top of the proof mass. A plurality of electrically-conductive transverse suspension arms or beams (that form flexural springs) extend laterally from the anchor beyond the lateral edges of the proof mass to the exterior support structure where they terminate at a plurality of electrodes. However, this prior art design also requires multiple separate electrode elements and suspension spring elements to suspend the proof mass from the frame and regulate travel of the proof mass between the multiple separate electrode components.

In view of the foregoing, there remains a need for new and improved MEMS accelerometer devices and associated production processes which address some of the limitations of existing devices and techniques according to the prior art. There also remains a need for improved MEMS accelerometer devices and associated production processes which may desirably provide one or more of improved sensitivity, reduced noise, design flexibility, simplified production and manufacturing, and reduced cost of accelerometer production.

### SUMMARY

It is an object of the present invention to provide a capacitive accelerometer sensor and a method for fabricating the same that address some of the limitations of the prior art. In one embodiment, the present invention comprises a structural design and general fabrication processes to develop highly sensitive, low-noise, and wideband accelerometers. In one such aspect, the device design may desirably be flexible allowing for simple modifications to device performance through straightforward structural adjustments. In one embodiment, the accelerometer device structure may be based on bonding two individually patterned substrates, each containing different segments of the device, together. In such an embodiment, the accelerometer device may comprise a capacitive interface with a plurality of electrodes formed on each of the two substrates that are separated from each other through precise microfabrication techniques.

In a particular embodiment, a capacitive accelerometer sensor is provided, comprising a first substrate and a second substrate wherein:

the first substrate comprises a resilient membrane comprising at least one first electrode and a proof mass attached to the resilient membrane;

the second substrate comprising at least one second electrode; and

wherein the first substrate and the second substrate are bonded to each other such that the first electrode of the resilient membrane on the first substrate faces the second electrode and is separated from the second electrode on the second substrate by a capacitive gap; and

wherein the first and second substrates comprise a plurality of openings and electrical contacts electrically connected to each of the first and second electrodes, respectively.

In another embodiment, the resilient membrane of the capacitive accelerometer sensor is fabricated on the first substrate by selective removal of material from the first substrate. In a further embodiment, the capacitive gap may be formed between the first and second electrodes by partial removal of material from at least one of the first and second substrates. In yet another embodiment, the capacitive gap may be defined by a spacer layer or a plurality of spacers between the first and second substrates. In one aspect, at least one of the first electrode and the second electrode may comprise an electrically conductive material deposited on an electrical insulator or semiconductor material. In another alternative aspect, the first electrode may comprise an electrically conductive material deposited above an insulating layer on top of the first substrate.

In another embodiment, the second electrode of the capacitive accelerometer sensor may comprise an electrically conductive material deposited on top of an intermediate layer above the second substrate. In a further embodiment, at least one of the first substrate and the second substrate may comprise a plurality of layers of different materials.

In a further embodiment, a method of fabricating a capacitive accelerometer sensor comprising a first substrate and a second substrate is provided, the method comprising:

forming a resilient membrane and a proof mass attached to said resilient membrane from said first substrate by selective material removal from said first substrate;

forming at least one first electrode on said resilient membrane;

forming at least one second electrode on said second substrate; and

bonding said first substrate to said second substrate such that said first electrode of said resilient membrane on said first substrate faces said second electrode and is separated from said second electrode on said second substrate by a capacitive gap; and

forming a plurality of openings in at least one of said first and second substrates to expose at least first and a second electrical contacts which are electrically connected to each of said first and second electrodes, respectively.

In one such embodiment, the method of fabricating a capacitive accelerometer sensor comprises using a suitable microfabrication process to form the resilient membrane and the attached proof mass.

### BRIEF DESCRIPTION OF THE DRAWINGS

Systems and methods according to several embodiments of the present invention will now be described with reference to the accompanying drawing figures, in which:

FIG. 1 illustrates a plan view of an exemplary MEMS accelerometer, comprising a square proof mass and ring accelerometer structure, according to an embodiment of the invention.

FIG. 2 illustrates a cross-sectional view of the accelerometer shown in FIG. 1 where spacers are used to set the gap between the electrodes, according to an embodiment of the invention.

FIG. 3 illustrates a plan view of exemplary MEMS accelerometer, comprising a circular proof-mass and ring membrane accelerometer structure, in accordance with an embodiment of the invention.

FIG. 4 illustrates a cross-sectional view of an exemplary MEMS accelerometer, where a multi-layer substrate is used as a first substrate, according to an embodiment of the present invention.

FIG. 5A illustrates a cross-sectional view of an exemplary MEMS accelerometer, where the second substrate is electrically isolated from the conductive layer for the second electrode using an insulating layer, according to an embodiment of the invention.

FIG. 5B illustrates a cross-sectional view of an exemplary MEMS accelerometer, where the second substrate comprises a conducting or semiconducting material and is used as the second electrode, according to an embodiment of the invention.

FIGS. 6A, 6B, 6C, 6D and 6E each illustrate a cross-sectional view of an exemplary electrical contact arrangement for electrical connection of different layers of the MEMS accelerometer structure, according to an embodiment of the invention.

FIG. 7A illustrates a cross-sectional view of an exemplary MEMS accelerometer, where the gap between the first and second electrodes is created by etching a cavity on the second substrate, according to an embodiment of the invention.

FIG. 7B illustrates a cross-sectional view of an exemplary MEMS accelerometer, where the gap between the first and second electrodes is created by etching a cavity on the first substrate, according to an embodiment of the invention.

FIG. 8A illustrates a cross-sectional view of an exemplary MEMS accelerometer, where dimples are created on the first substrate of the accelerometer structure, according to an embodiment of the invention.

FIG. 8B illustrates a cross-sectional view of an exemplary MEMS accelerometer, where dimples are created on the second substrate of the accelerometer structure, according to an embodiment of the invention.

FIGS. 9A, 9B and 9C each illustrate a plan view of exemplary embodiments of the electrode on the second substrate of the MEMS accelerometer, in accordance with an embodiment of the present invention.

FIGS. 10A and 10B illustrate perspective views of a typical accelerometer, according to an embodiment, that was subjected to experimentation.

FIG. 11 is a graph showing the measured frequency response of the accelerometer shown in FIGS. 10A and 10B.

FIG. 12 is a graph showing the measured output voltage as a function of acceleration for a 200 Hz sinusoidal input to the accelerometer shown in FIGS. 10A and 10B.

FIG. 13 is a graph showing measured noise as a function of frequency for the accelerometer shown in FIGS. 10A and 10B.

It will be understood that the above-described drawing figures illustrate exemplary embodiments of the present invention, and the scope of the present invention is not limited by the exemplary illustrated embodiments. A more complete understanding of the present disclosure may be achieved by referring to the below detailed description and claims, when considered in connection with the figures. It should be noted that the figures are not necessarily drawn to scale.

### DETAILED DESCRIPTION OF SEVERAL EMBODIMENTS

In one aspect, an accelerometer sensor may be modeled as a mechanical mass-spring-damper system. A typical MEMS accelerometer may be represented as a proof mass, M, that is suspended within a frame using springs with total stiffness of, K, along the desired axis of sensitivity. Various forms of damping may be modeled, such as a damper with damping ζ.

Newton's and Hooke's law imply conservations of energy in the mass-spring system:

F=Ma=KΔx (1)

where M is the effective mass of proof mass (in kg), Δx is its displacement (in m), a is input acceleration (in m/s²), and K is the effective spring constant of the structure (in N/m). Based on equation (1), the displacement of the proof mass may be expressed as:

$$Δ x = \frac{M a}{K} \qquad ( 2 )$$

The fundamental resonance frequency of accelerometer, ω₀ in rad/s, which typically limits its useful operational bandwidth, may be given by:

$${ω}_{0} = \sqrt{\frac{K}{M}} \qquad ( 3 )$$

Substituting equation (3) in (2) leads to,

$$Δ x = \frac{a}{{ω}_{0}^{2}} \qquad ( 4 )$$

For capacitive accelerometer devices, this displacement is converted to a change in capacitance such as by using a variety of electrode configurations. If the displacements are measured based on the change in a gap between two parallel electrodes with effective areas of A separated from each other with an initial gap of d, the change in capacitance for |Δx|<<d may be expressed by:

$$Δ C = \frac{ɛ A}{d} - \frac{ɛ A}{d - Δ x} \approx \frac{ɛ A}{{d}^{2}} Δ x = \frac{{C}_{0}}{d} Δ x \qquad ( 5 )$$

where ε is the permittivity of the dielectric medium (e.g., air) between the two electrodes (in F/m) and

$${C}_{0} = \frac{ɛ A}{d}$$

is the initial capacitance of the device at rest. The accelerometer device response may typically turn nonlinear as Δx becomes comparable to d due to large input accelerations. The device sensitivity may be defined as the change in measured capacitance relative to acceleration applied to the device and is found from equations (4) and (5):

$${S}_{a}^{C} = \frac{{C}_{0}}{d {ω}_{0}^{2}} \qquad ( 6 )$$

Finally, the spectral density of the Brownian acceleration noise exerted onto the proof mass of the accelerometer, [symbol] in

$$\frac{m / {s}^{2}}{\sqrt{Hz}} ,$$

may be represented by:

$$= \frac{\sqrt{4 {k}_{B} T ζ}}{M} = \sqrt{4 {k}_{B} T \frac{{ω}_{0}}{MQ}} \qquad ( 7 )$$

where Q is the quality factor of the device, T is absolute temperature in ° K, and k_{B} is the Boltzmann's constant in J/° K.

As equations (3) to (7) demonstrate, there may typically be tradeoffs between the operating bandwidth, displacements of the proof mass, sensitivity, linearity, and noise floor related to the configuration and orientation of a MEMS accelerometer design. For example, increasing the proof mass alone leads to a lower noise, but also reduces the effective operational bandwidth. Increasing the spring constant, on the other hand, improves the bandwidth while reducing the proof mass displacements which ultimately affect the device sensitivity. One approach to increase the sensitivity of the device is to increase the rate of change in capacitance per unit displacement through increasing the electrode area. In one aspect, an out-of-plane accelerometer design may generally offer relatively large electrode areas. Another method to increase sensitivity may comprise decreasing the gap between the electrodes. However, this approach may adversely affect the linearity (i.e., dynamic range) of the accelerometer device under large input accelerations. To overcome this challenge, most sensitive accelerometers typically employ a closed-loop control topology to improve the linear range of operation by applying opposing forces such as damping forces to the proof mass to reduce its displacements in response to input accelerations. In one such aspect, the springs attaching the proof mass to the frame may typically comprise suspension beams of various shapes. This, however, may in some cases lead to cross-axis sensitivity of the device to in-plane accelerations.

In one embodiment according to the present invention, a MEMS accelerometer structure is described which desirably provides a MEMS accelerometer structure for the detection of out-of-plane acceleration signals and desirably with low sensitivity to off-axis signals. In one such embodiment, the MEMS accelerometer structure may also desirably provide for a sensitive, wideband and low noise accelerometer sensor.

In a particular embodiment according to the present invention, a MEMS accelerometer is provided, comprising a proof mass that is attached to a resilient membrane made having an integral first electrode, formed from or patterned on top of a first substrate, and a fixed second electrode on a second substrate that is bonded to the first substrate to allow for capacitive detection of proof mass displacements by changes in capacitance between the first and second electrodes. In one aspect, using the entire thickness of the first substrate for the proof mass may desirably allow for the design of a low-noise accelerometer sensor. In another aspect, using a resilient membrane for the spring suspending the proof mass may desirably provide for reducing the cross-axis sensitivity of the accelerometer device. In yet another aspect, precise bonding processes may desirably provide for realization of a narrow electrode gap between first and second electrodes that may desirably improve the sensitivity of the accelerometer device. In one embodiment, provision of feedback control may be possible through applying suitable control signals to the second electrode(s) on the second substrate.

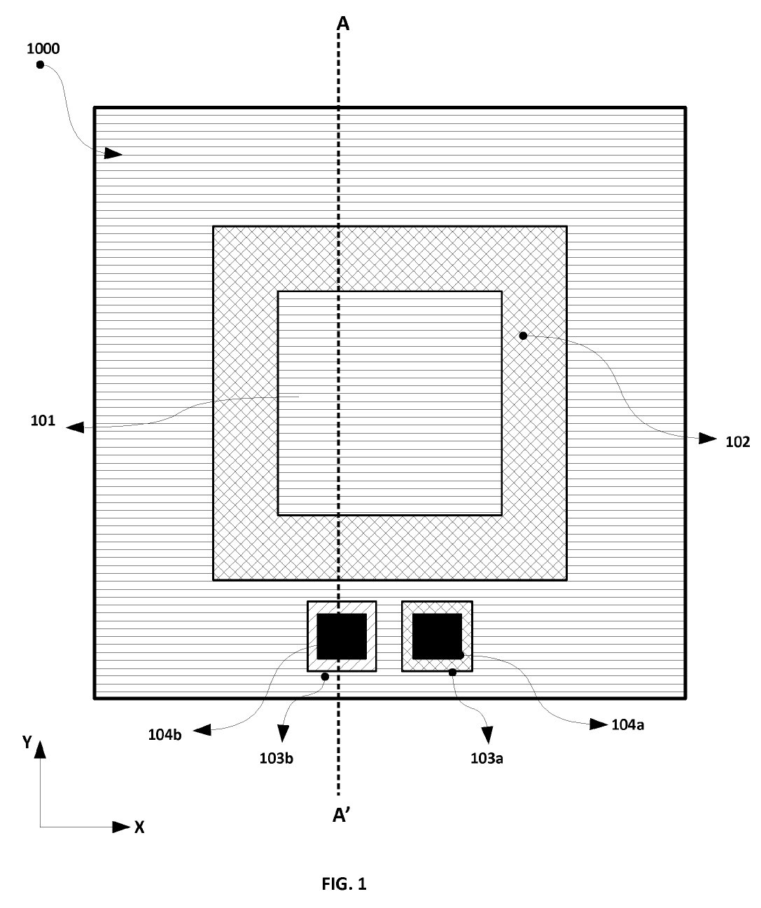

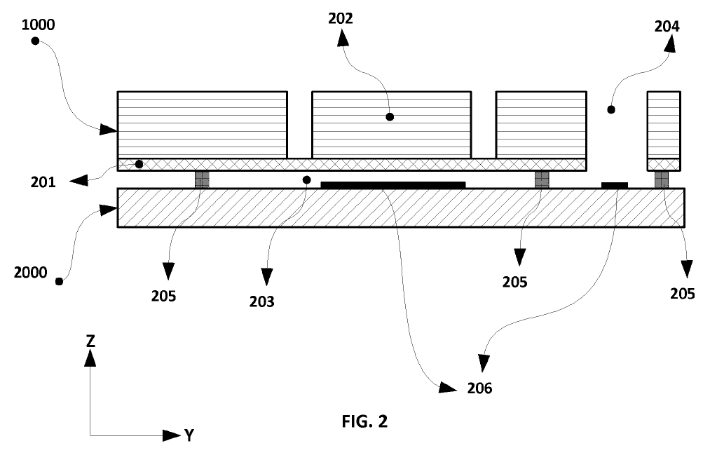

Referring now to the drawings, in FIG. 1, a plan view of an exemplary MEMS accelerometer, comprising a square proof mass (101) and square ring membrane (102) elements of the accelerometer structure is shown, according to an embodiment of the invention. In one aspect, the MEMS accelerometer may comprise a body substrate (1000), a proof mass (101) attached to a resilient membrane (102), a first opening (103a) and membrane electrical contact (104a) to provide electrical connection to the membrane (102), as well as second opening (103b) and electrode electrical contact (104b) to provide electrical connection to the second electrode (104b), which are visible in the plan view shown as FIG. 1. In one such embodiment, the proof mass (101) and membrane (102) may be made from the material comprising the first substrate (1000), such as by micromachining processes, for example. The resilient membrane (102) may be a solid or continuous structure, or may include one or more openings, e.g., openings formed by perforation. A cross-sectional view of the MEMS structure shown in FIG. 1 taken along line A-A′ is shown as FIG. 2, as detailed below.

In one such embodiment, the MEMS accelerometer structure may be fabricated on a suitable first substrate material (1000) such as by selective removal of mass from the substrate (1000) to form a resilient membrane (102) and proof mass (101) that is attached to the membrane (102). In addition to providing the mechanical restoring force as a spring, the resilient membrane (102), or at least a portion of it, may also be configured to serve as the first electrode for the capacitive accelerometer, such as in an exemplary embodiment where the membrane comprises a conducting or semiconducting material, for example. In one such embodiment, at least a portion of the resilient membrane (102) may be configured as a first electrode by any suitable known technique, such as by applying a film of a conducting and/or semiconducting material directly to the membrane (102). In a particular embodiment, the membrane (101) may be comprised of a conductive and/or capacitive material and may thereby function as a first electrode integrated with the membrane (102). In another embodiment, the first electrode may be formed by any suitable known technique, such as by applying a film of a conducting and/or semiconducting material on an intermediate layer above the membrane (102).

FIG. 2 illustrates a cross-sectional view of the accelerometer shown in FIG. 1, where spacers (205) are used to set the gap between the first electrode formed by the resilient membrane (201), and the second electrode (206) formed on a second substrate (2000) which is bonded to the first substrate (1000), according to an embodiment of the invention. In one such embodiment, a second electrode (206) may be made on at least a portion of the second substrate (2000) by any suitable known method, such as by applying a film of a conductive and/or capacitive material to the second substrate (2000), for example. In one aspect, the two substrates (1000) and (2000) may then be bonded to each other such that a gap (203) separates the two electrodes from each other and the first and second electrodes remain electrically isolated. In another aspect, one or more openings (204) may be provided to expose the first electrode on membrane (201) and the second electrode (206) on second substrate (2000) such that the first and second electrodes can be connected to a suitable electronic interface (not shown) to provide for measurement of changes in capacitance of the accelerometer as the proof mass (202) is displaced with respect to the second substrate (2000) due to input accelerations. In one embodiment, one or more openings (204) to expose the first and second electrodes may be created before or after the bonding of the first and second substrates (1000) and (2000). In a particular exemplary embodiment shown in FIG. 2, the gap between the first and second electrodes is set by the thickness of one or more spacers (205) situated between the first substrate (1000) and second substrate (2000) as they are bonded together. In one aspect, the spacers (205) may be deposited or placed selectively on one or both of first (1000) and second (2000) substrate wafers. In an alternative manufacturing process according to one embodiment, the spacers (205) may be created by selective removal of material from one or more thin film(s) that is (are) deposited on one or both of first (1000) and second (2000) substrates. In a further variation, a passage or channel such as a microchannel may be included (a microchannel through second substrate (2000), for example) that fluidly connects the gap (203) with the exterior environment. Such a passage may allow for air to leave or enter the gap (203) in response to changes in shape by resilient membrane (201).

In other alternative configurations, various proof mass and membrane geometries may be substituted in the MEMS accelerometer sensor according to embodiments of the present invention. FIG. 1 illustrates an exemplary embodiment showing a top view of a particular accelerometer comprising a substantially square proof mass (101) and membrane (102) shape, with contact openings (103a) and (103b) arranged along a side of the accelerometer chip.

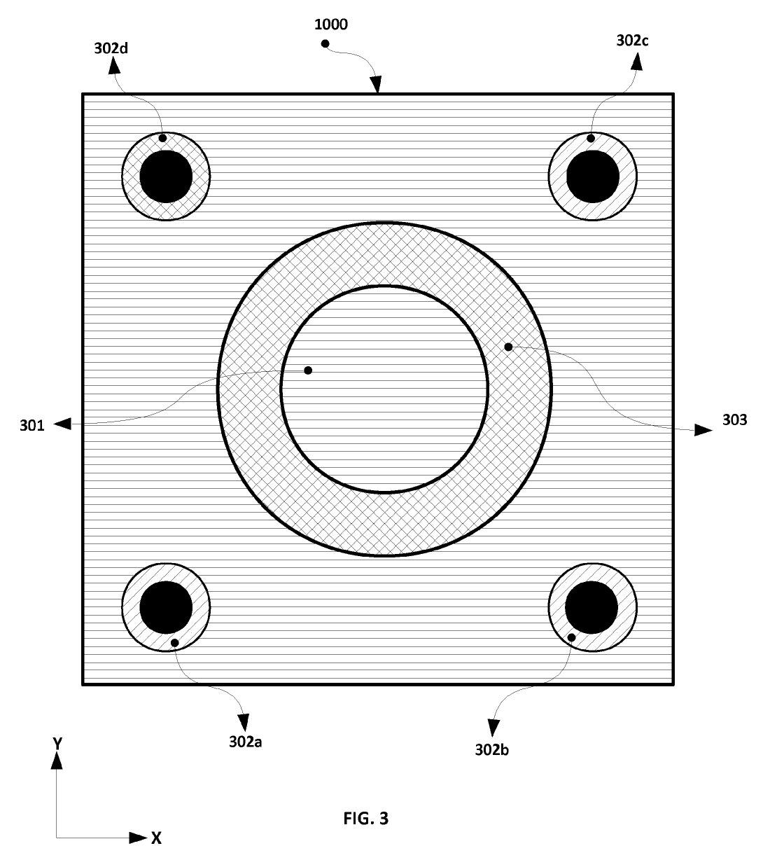

In an alternative embodiment, FIG. 3 illustrates a plan view of an exemplary MEMS accelerometer, comprising a substantially circular proof mass (301) and resilient ring shaped membrane (303) formed in a first substrate (1000) to form the accelerometer structure, in accordance with another embodiment of the invention. In one aspect, the accelerometer embodiment shown in FIG. 3 also comprises contact openings (302a) to (302d) arranged around the ring shaped membrane (303), shown in this embodiment substantially situated at the corners of the accelerometer chip.

In one embodiment, the first substrate (1000) of the accelerometer structure can be made from any suitable substrate material or combination of suitable materials, and the proof mass (101) and resilient membrane (102) features may be formed in the first substrate (1000) using any suitable technique or combination of techniques, such as micro-milling, etching, ablative and/or other micromachining techniques, for example. In a particular embodiment in which the first substrate (1000) is made of silicon, a range of suitable known patterning/etching/ablating techniques adapted for use on silicon based substrates can be employed to pattern the proof mass (101) and resilient membrane (102) features of the accelerometer structure based on silicon microfabrication processes.

In one aspect, the proof mass (101) structure and openings to contacts with the first electrode and second electrodes can be created through selective removal of the substrate material such as by using one or more suitable known etching techniques. For example, wet etching of crystalline silicon may be conducted to achieve proof mass and opening structures with predefined sidewall angles. In another aspect, gas-phase dry etching techniques may be employed to achieve nearly vertical sidewalls. In a further aspect, the thickness of the resilient membrane (102) can be controlled based on the substrate and employed etching technique. In the simplest such case, the etch depth from the surface of the first wafer can be controlled through timing the etching process. However, timed etching often suffers from non-uniformity across the wafer or problems limiting repeatability between wafers for batch-fabricated devices. In an alternative aspect, another option comprising selecting the desired membrane thickness through electrochemical and/or dopant-based etch stops. In one such aspect, such etch stop techniques may only be applicable to embodiments utilizing wet etching processes.

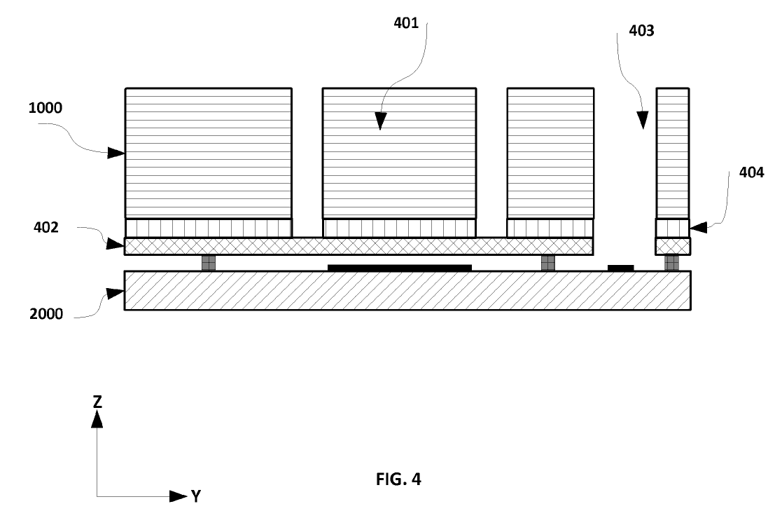

In a further embodiment, multi-layer substrates may be used to desirably simplify the manufacturing process. FIG. 4 illustrates a cross-sectional view of an exemplary MEMS accelerometer, where a multi-layer substrate is used as a first substrate (1000), according to an embodiment of the present invention. In one such embodiment, the thickness of different substrate layers may be selected to define the desired height of the proof mass (401) and desired thickness of the resilient membrane (402) features on the finished first substrate (1000) wafer. In another aspect, suitable selective material removal processes may be employed to form the proof mass (401) and resilient membrane (402) features, based on the physical and chemical properties of these substrate material layers. Accordingly, suitable selective material removal processes may be applied to particular embodiments utilizing both wet and dry etching processes, for example. In one aspect, an example of a potentially suitable such multi-layer substrate is a silicon-on-insulator (SOI) wafer. In one such embodiment, an SOI wafer may comprise a top silicon layer (i.e., a top device layer), situated on top of a typically relatively thin silicon dioxide middle layer (i.e., a middle buried oxide layer), which is situated above another bottom silicon layer (i.e., a bottom handle layer). In one aspect, in an exemplary MEMS fabrication process, the thickness of the top device layer may range from a few tens of nm to a few hundreds of μm, while the thickness of the middle buried oxide layer may range between a few tens of nm to a few μm thick, for example. In one aspect, the thickness of the bottom handle layer may typically be in the range of few hundreds of μm, for example. In a particular embodiment, the thicknesses of all these layers of the multi-layer first substrate (1000) may desirably be simply and precisely controlled during the SOI wafer manufacturing process, such as by using suitable known wafer manufacturing techniques.

As shown in FIG. 4, with a multi-layer first substrate (1000), the proof mass (401) can be formed from one layer (such as an exemplary silicon handle layer) and the membrane (402) may be formed from another layer (such as an exemplary silicon device layer). For instance, in one particular embodiment, the bottom handle wafer of an SOI wafer can be patterned to form the proof mass (401) and one or more openings (403) to expose contacts. The resilient membrane (402), on the other hand, can in one such embodiment be formed from a device layer of an exemplary SOI wafer. In a particular such embodiment, the insulating layer (404) of an exemplary SOI wafer may serve as an etch-stop layer and may optionally be removed, such as from the exposed areas of the membrane, later if needed or desired.

In one embodiment, the second substrate (2000) layer may be formed from a suitable electrically insulating material, such as an insulating glass, for example, in which case the second electrode may be directly deposited and patterned on the second substrate layer (2000), such as is shown in the exemplary embodiment illustrated in FIG. 4.

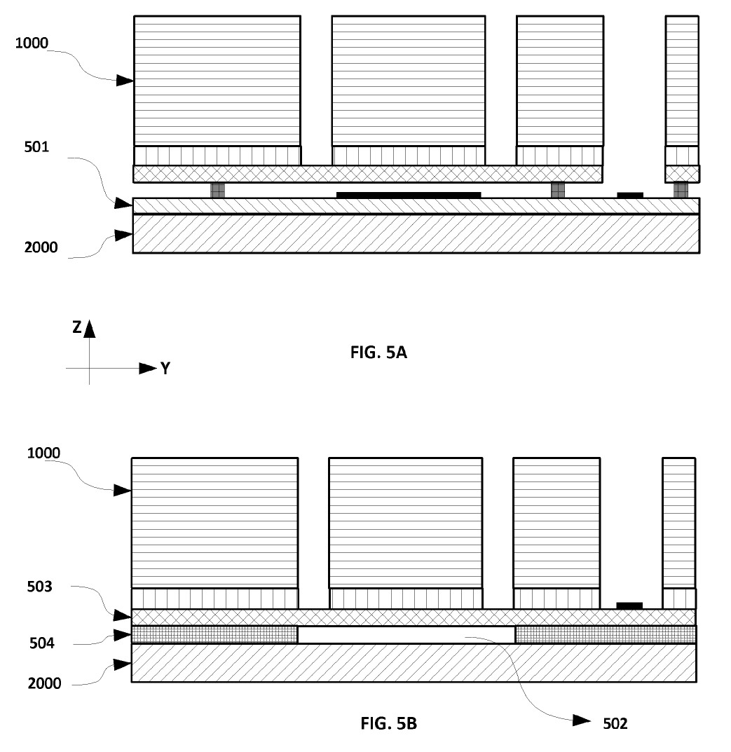

FIG. 5A illustrates a cross-sectional view of an exemplary MEMS accelerometer according to another embodiment of the present invention, where the second substrate (2000) is electrically isolated from the conductive layer for the second electrode using an insulating layer (501). In one such alternative aspect, if the second substrate (2000) is made from a conducting or semiconducting material (e.g., silicon), an electrical insulator layer (501) may be deposited on its surface prior to deposition and patterning of the second electrode as illustrated in the exemplary structure shown in FIG. 5A. In one such embodiment, deposition of an intermediate insulating layer (501) may also be desirable due to fabrication requirements such as the need for an adhesion layer or a diffusion barrier, for example.

FIG. 5B illustrates a cross-sectional view of an exemplary MEMS accelerometer according to another embodiment of the present invention, where the second substrate (2000) is electrically conducting or semiconducting and is used as the second electrode. In one such embodiment, the membrane (503) on the first substrate functions as the first electrode while the second substrate (2000) functions as the second substrate. The first and second electrodes are separated from each other, such as by using insulating spacers or an insulating spacer layer (504) that is suitably patterned, also forming the desired capacitive gap (502).

In one aspect, electrical connections are typically needed to provide for connection to the two electrode layers of the first and second substrates (1000) and (2000) in order to be able to measure capacitance variations due to movement of the proof mass.

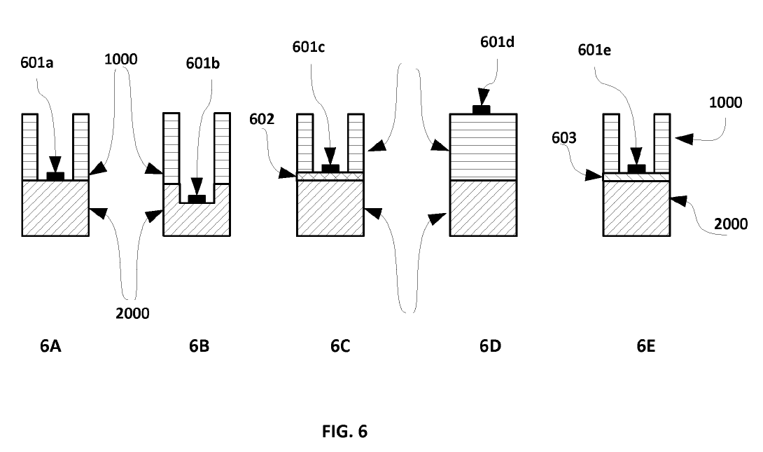

FIGS. 6A, 6B, 6C, 6D, and 6E each illustrate a cross-sectional view of an exemplary electrical contact arrangement for electrically connection of different substrate layers of the MEMS accelerometer structure, according to an embodiment of the invention. In one aspect, FIG. 6A illustrates a first exemplary electrical contact (601a) is applied to and in conductive contact with the conducting layer on the surface of the second substrate (2000). In another aspect, FIG. 6B illustrates a second exemplary electrical contact (601b) applied to and in conductive contact with the conducting layer within a cavity etched on the surface of the second substrate (2000). In a further aspect, FIG. 6C illustrates a third exemplary electrical contact (601c) applied to and in conductive contact with a conducting layer on the membrane layer (602) of the first substrate (1000). In yet a further aspect, FIG. 6D illustrates an exemplary electrical contact (601d) applied to and in conductive contact with the handle layer of the first substrate (1000). In yet a further aspect, FIG. 6E illustrates an exemplary electrical contact (601e) applied to and in conductive contact with a conducting layer on the top of an intermediate layer (603) which is on top of the second substrate (2000). It is understood that the exemplary first substrate (1000) and/or the second substrate (2000) shown in FIGS. 6A, 6B, 6C, 6D, and 6E may be provided as multi-layer substrates in other aspects of the invention, even though a single material substrate is shown for simplicity if the figures. In some embodiments, it may be desired to provide one larger opening to expose multiple electrical contacts to different layers of the first substrate (1000) or second substrate (2000) components of the accelerometer structure, for example.

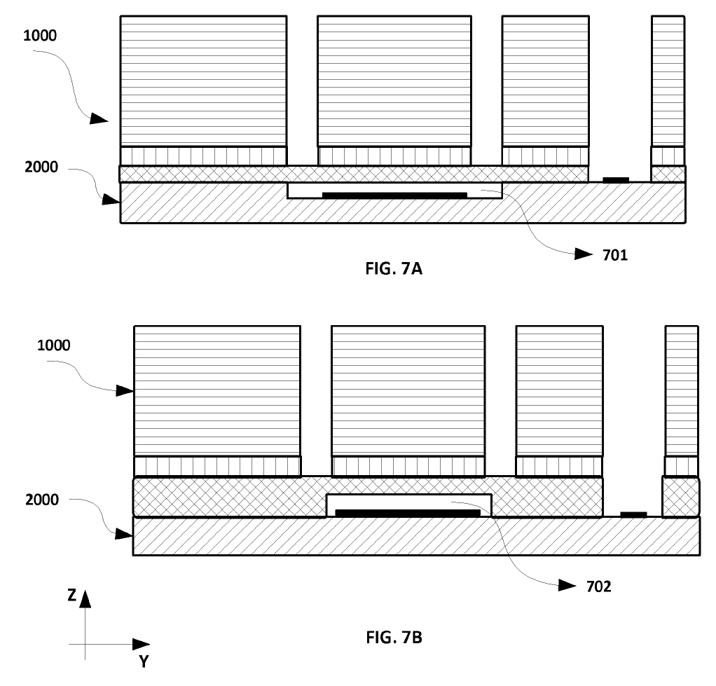

FIG. 7A illustrates a cross-sectional view of an exemplary MEMS accelerometer, where the gap between the first and second electrodes is created by etching a cavity (701) on the second substrate (2000), according to an embodiment of the invention. In one such embodiment, the gap between the electrodes can also be created by etching cavities in each or both of the first (1000) and second (2000) substrates. In one such aspect, a spacer layer may desirably not be required, and the first (1000) and second (2000) substrates may desirably be directly bonded to each other. In a particular such embodiment, the direct bonding of the first (1000) and second (2000) substrates to each other without a spacer, may desirably provide for an improved bond quality, and also may desirably provide for increased process simplicity and/or process repeatability. In one such aspect, the desired gap between the first and second electrodes may be adjusted by modifying the depth of the cavity (701) formed in or on one or both of the first and/or second substrates. In the particular embodiment shown in FIG. 7A, the gap between the electrodes is created by etching a cavity (701) on the surface of the second substrate (2000). In this case, the conducting layer to pattern the second electrode on the second substrate (2000) may be deposited inside the recessed cavity (701). In one such embodiment, electrical contact to the membrane layer in the first substrate (1000) may be provided by extending a conductive layer from within the cavity(ies) (701) to the surface of the second substrate (2000), where it may be pressed against, and potentially amalgamate with the material from the first substrate (1000), thereby providing electrical contact with the membrane portion of the first substrate (1000).

FIG. 7B illustrates a cross-sectional view of an exemplary MEMS accelerometer, where the gap between the first and second electrodes is created by etching a cavity (702) on the first substrate (1000), according to an alternative embodiment of the invention. In one such embodiment, a gap between the first (1000) and second (2000) substrate may be created by etching a cavity (702) on the resilient membrane surface of the first substrate (1000), such as by removing material from the bottom of the membrane layer of the first substrate (1000). In a particular aspect, the gap between the first and second substrates may alternatively be realized by etching cavities on both first and second substrates, if desired. In another embodiment, both substrates (1000) and (2000) may be etched to create the capacitive gap between the substrates. It is understood that while exemplary multi-layer first substrate (1000) wafers are shown in FIGS. 7A and 7B, the same principles apply to a first substrate wafer made from a single material or a first substrate wafer made from a single material with later modifications to some material properties, such as by using doping, for example. In another embodiment, in order to reduce the possibility of stiction of the flexible membrane to the second electrode during or after fabrication of the devices, dimples or other suitable raised or indented textured structures may be created on at least a portion of the first substrate or second substrate, such as in a position to prevent contact of parallel substantially planar surfaces of the flexible membrane and second electrode, for example.

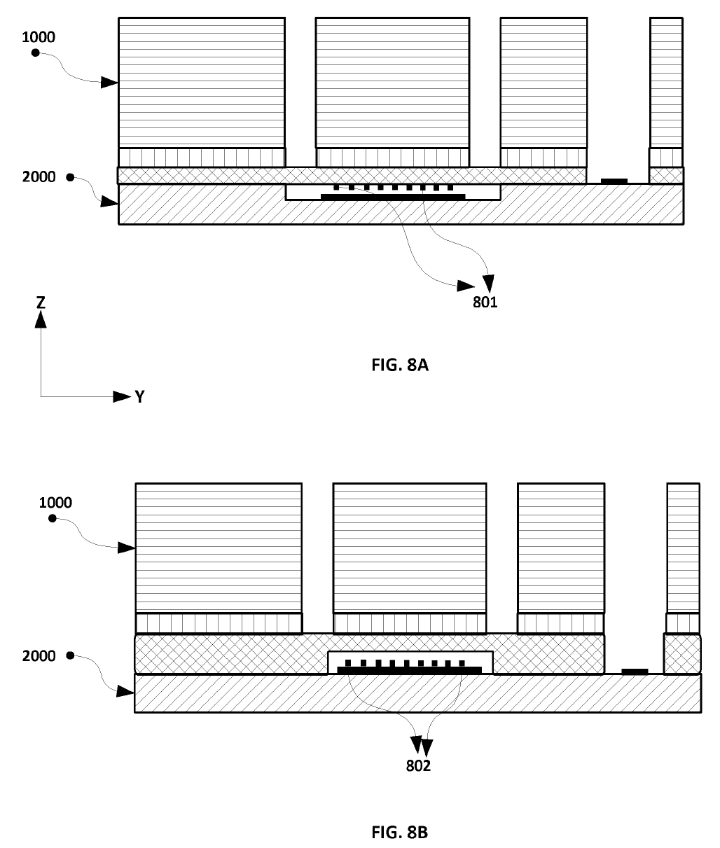

FIG. 8A illustrates a cross-sectional view of an exemplary MEMS accelerometer, where dimples (801), or optionally or other suitable raised or indented textured structures, are created on the first substrate (1000) of the accelerometer structure, according to an embodiment of the invention.

FIG. 8B illustrates a cross-sectional view of another exemplary MEMS accelerometer, where dimples (802), or other suitable raised or indented textured structures, are created on the second substrate of the accelerometer structure, according to an embodiment of the invention.

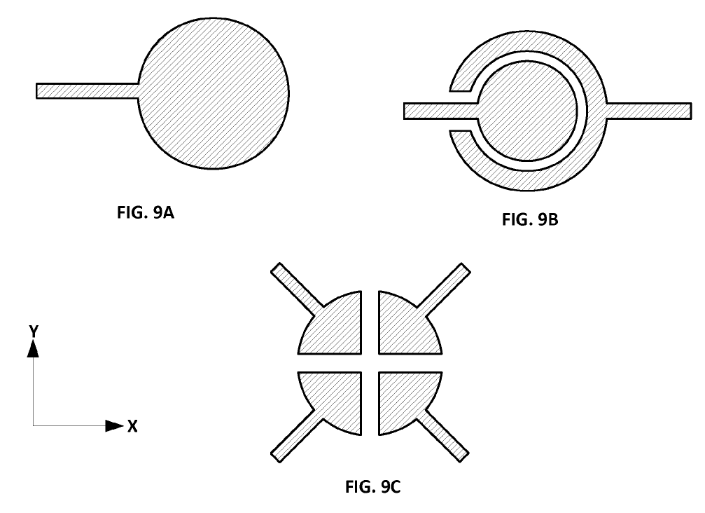

FIGS. 9A, 9B and 9C each illustrate a plan view of an exemplary embodiment of a second electrode patterned on the second substrate of a MEMS accelerometer, in accordance with an embodiment of the present invention. In one aspect, FIG. 9A shows a first configuration for the second electrode on the second substrate (2000) where a single electrode is patterned and used to measure the displacements of the proof mass suspended above it, by means of measuring the variation in capacitance between the second electrode and a first electrode situated on the membrane of the first substrate (1000). In a particular embodiment, closed-loop control of the accelerometer sensor may be desired. In one such embodiment, such closed-loop control may be provided by applying a suitable DC bias voltage between the first and second electrodes so that the proof mass and attached resilient membrane on the first substrate (1000) is initially biased, deflected or pulled towards the second electrode on the second substrate (2000). In one such embodiment, during accelerometer sensor operation, the bias voltage may be modified so that the combination of the electrostatic force from the bias voltage, the mechanical restoring force of the resilient membrane, and the force due to input accelerations substantially balance each other.

In another aspect, it may be desirably simpler from an interface circuit design perspective to separate the second electrode into at least two segments where one segment is used for sensing displacements of the first electrode attached to the proof mass, and another segment is used to apply an electrical signal for feedback control, calibration, and/or self-test. FIG. 9B illustrates a second such configuration for the second electrode on the second substrate (2000) where the second electrode is patterned as two concentric segments, including one central segment and a second peripheral segment, for example.

In a further aspect, it may be desirable to provide additional second electrode segments for the second electrode on the second substrate (2000), such as to perform further functions. In one such exemplary embodiment, in-plane accelerations may be measured through partitioning the second electrode into four segments as shown in FIG. 9C. In such an aspect, FIG. 9C shows a third configuration for the second electrode on the second substrate (2000) where four separate second electrode segments are patterned. In such an embodiment, out-of-plane accelerations can be detected by measurement of the change in total capacitance between all four second electrode segments on the second substrate (2000) and the first electrode attached to the proof mass of the first substrate (1000). In-place accelerations along x or y axes may cause tilting of the proof mass that can be detected by measuring the difference between the capacitances of each one of the four second electrode segments and the first electrode attached to the proof mass, for example. In one aspect, additional contact openings may be provided to expose each of the second electrode segments for applying suitable electrical connections to each of the second electrode elements. It may be noted that the electrode configurations illustrated in FIGS. 9A to 9C are exemplary and for illustrative purposes only and that other shapes and numbers of electrodes and electrode segments can be employed to achieve a desired performance or functionality according to alternative embodiments of the invention.

Although the preceding description discloses details of structure and functionality of several exemplary embodiments of the present invention, it should not be considered as limiting the scope of the invention but rather as providing explanation and illustration of particular aspects of the invention so as to enable a person of skill in the art to understand and practice the disclosed embodiments.

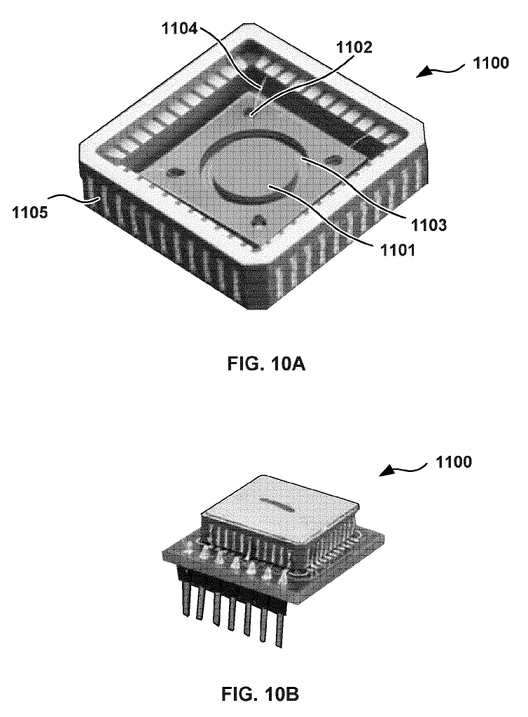

FIGS. 10A and 10B are perspective views of an illustrative accelerometer (1100). As shown in FIG. 10A, accelerometer (1100) includes a proof mass (1101) with a circular face, a typical contact opening (1102) and a resilient ring shaped membrane (1103). A typical electrical contact (1104) is shown disposed in the typical contact opening (1102). Structures such as a second substrate layer and spacers and capacitive gap are not depicted in FIG. 10A. The package or another (1105) support structure may offer, among other things, simple access to device electrical ports and protection of the components. In FIG. 10B, the accelerometer (1100) is assembled into a working model constructed according to various techniques described above.

The working model, fabricated as a low-noise wide-bandwidth accelerometer, was subjected to experimentation. Although mathematical modeling can indicate possible performance, it is recognized that experimentation with working models can reveal performance aspects (desirable or undesirable) that are not necessarily predicted by modeling.

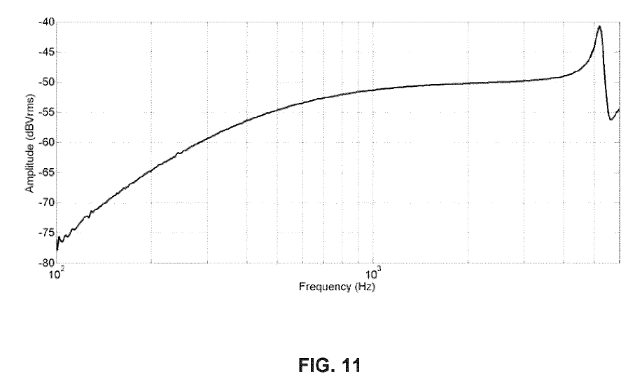

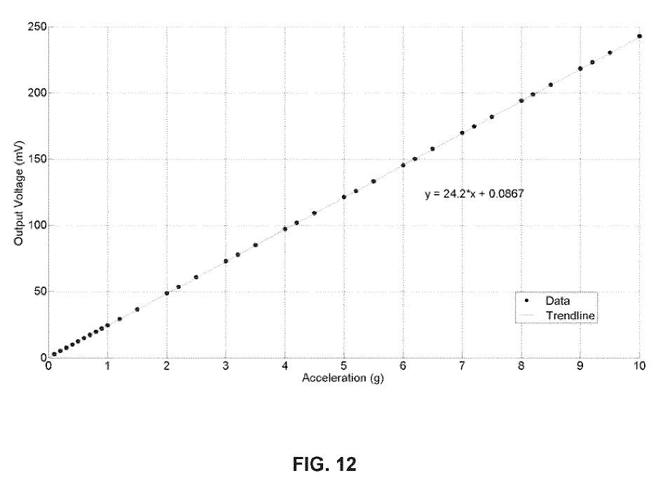

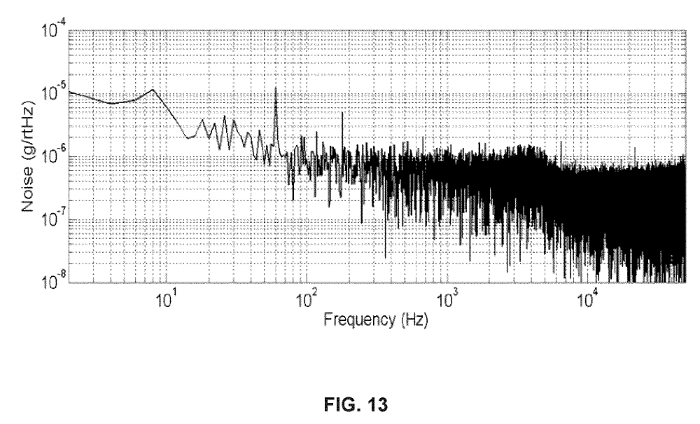

While in use, the device may be held at a suitable pressure according to the application requirements and packaging capabilities. The measured frequency response of the accelerometer is shown in FIG. 11. This measurement was conducted under vacuum in order to detect the resonance peak for the fundamental mode of the structure; FIG. 11 shows this peak at about 5.2 kHz. All other tests were conducted with the accelerometer kept at atmospheric pressure. FIG. 12 illustrates measurements on the linearity of the device response to a 200 Hz sinusoidal input using a mechanical shaker. During this test the accelerometer was subjected to input accelerations from 100 mg to 10 g without exhibiting nonlinearity. Experimental data indicate a strong linear correlation between acceleration and output voltage, over a range of accelerations, including a range of accelerations to which human beings might be subject in the course of ordinary activities. Further, the observed linearity indicates precise evaluation of factors or quantities related to acceleration, such as velocity, displacement or direction. The noise of the accelerometer was measured and separated from ambient noises using spectral coherence noise measurement technique. As shown in FIG. 13, the measured noise level from 50-5000 Hz was almost 1 μg/√Hz at atmospheric pressure, dominated by circuit noise rather than the MEMS device. Although mathematical modeling indicated potential for various aspects of performance, the results of experimentation indicate that the potential advantages outlined herein can be readily realized. A notable advantage and variation of the developed system (in comparison to other accelerometers) is achieving wide working frequency band and low noise performance in a single device. A device of this kind could be applied in applications in which other devices may not perform as well, such as phased-array applications.

While the present invention and its various functional components and operational functions have been described in particular exemplary embodiments, the invention may also be implemented in hardware, software, firmware, middleware or a combination thereof and utilized in systems, subsystems, components or subcomponents thereof, for example, as circuitry that cooperates with a processor to perform various method steps. In particular embodiments implemented at least in part in software, elements of the present invention may comprise instructions and/or code segments to perform the necessary tasks. The program or code segments may be stored in a machine readable medium, such as a processor readable medium or a computer program product, or transmitted by a computer data signal embodied in a carrier wave, or a signal modulated by a carrier, over a transmission medium or communication link. The machine readable medium or processor readable medium may include any medium that can store or transfer information in a form readable and executable by a machine, for example a processor, computer, etc. Various functional components may be implemented as one-piece or multi-piece constructions. Various components that are attached or are bonded to one another may be so attached or bonded by any of several attachment or bonding instrumentalities, in some cases including one-piece construction.

It will be appreciated that the term “or” as used herein refers to a non-exclusive “or” unless otherwise indicated (e.g., use of “or else” or “or in the alternative”).

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from scope thereof. Accordingly, the scope of the invention is to be construed in accordance with the substance defined by the claims.

What is claimed is:

1. A capacitive accelerometer sensor, comprising a first substrate and a second substrate wherein:
said first substrate comprises a resilient membrane comprising at least one first electrode and a proof mass attached to said resilient membrane;
said second substrate comprising at least one second electrode; and
wherein said first substrate and said second substrate are bonded to each other such that said first electrode of said resilient membrane on said first substrate faces said second electrode and is separated from said second electrode on said second substrate by a capacitive gap; and
wherein said first and second substrates comprise a plurality of openings and electrical contacts electrically connected to each of said first and second electrodes, respectively.

2. The capacitive accelerometer sensor according to claim 1, wherein said resilient membrane is fabricated on said first substrate by selective removal of material from said first substrate.

3. The capacitive accelerometer sensor according to claim 1, wherein said capacitive gap is formed between said first and second electrodes by partial removal of material from at least one of said first and second substrates.

4. The capacitive accelerometer sensor according to claim 1, wherein said capacitive gap is defined by at least one of a spacer layer or plurality of spacers between said first and second substrates.

5. The capacitive accelerometer sensor according to claim 1, wherein at least one of said first electrode and said second electrode comprises at least one of an electrically conducting or semiconducting material deposited on said respective first and/or second substrates.

6. The capacitive accelerometer sensor according to claim 1, wherein at least one of said first electrode and said second electrode comprises an electrically conducting or semiconducting material deposited above an insulating layer on said respective first and/or second substrates.

7. The capacitive accelerometer sensor according to claim 1, wherein said resilient membrane made from said first substrate comprises at least one of a conducting or semiconducting material and functions as said first electrode.

8. The capacitive accelerometer sensor according to claim 1, wherein said second substrate comprises at least one of a conducting or semiconducting material and functions as said second electrode.

9. The capacitive accelerometer sensor according to claim 1, wherein at least one of said first substrate and said second substrate comprises a plurality of layers of different materials.

10. The capacitive accelerometer sensor according to claim 1, wherein said first and second substrates are bonded directly to each other without an intermediate layer.

11. The capacitive accelerometer sensor according to claim 1, additionally comprising an intermediate layer between said first and second substrates.

12. The capacitive accelerometer sensor according to claim 11, wherein said intermediate layer is electrically conductive.

13. The capacitive accelerometer sensor according to claim 11, wherein said intermediate layer is electrically insulating.

14. The capacitive accelerometer sensor according to claim 1, wherein said resilient membrane is perforated.

15. The capacitive accelerometer sensor according to claim 1, additionally comprising a passage fluidly connecting said capacitive gap with an environment external to the sensor.

16. The capacitive accelerometer sensor according to claim 1, wherein at least one of said first and second electrodes comprises a multiple-segment electrode configuration.

17. The capacitive accelerometer sensor according to claim 1, wherein at least one of said first and second electrodes comprises dimples.

18. The capacitive accelerometer sensor according to claim 1, wherein said openings are patterned in at least one of said first and second substrates and expose a portion of at least one of said first and second electrodes.

19. A method of fabricating a capacitive accelerometer sensor comprising a first substrate and a second substrate, comprising:
forming a resilient membrane and a proof mass attached to said resilient membrane from said first substrate by selective material removal from said first substrate;
forming at least one first electrode on said resilient membrane;
forming at least one second electrode on said second substrate; and
bonding said first substrate to said second substrate such that said first electrode of said resilient membrane on said first substrate faces said second electrode and is separated from said second electrode on said second substrate by a capacitive gap; and
forming a plurality of openings in at least one of said first and second substrates to expose at least first and a second electrical contacts which are electrically connected to each of said first and second electrodes, respectively.

20. The method of fabricating a capacitive accelerometer sensor comprising a first substrate and a second substrate according to claim 19, wherein said resilient membrane and said attached proof mass are formed through a microfabrication process.
